(19) United States
(12) Patent Application Publication
(10) Pub. No.: US 2018/0009348 A1
(43) Pub. Date: Jan. 11, 2018

(54) VEHICLE SEATING AND METHODS AND VEHICLES USING THE SAME

(71) Applicant: SABIC GLOBAL TECHNOLOGIES B.V., Bergen op Zoom (NL)

(72) Inventor: Bhushan Deshmukh, Bangalore (IN)

(21) Appl. No.: 15/712,846

(22) Filed: Sep. 22, 2017

Related U.S. Application Data
(63) Continuation-in-part of application No. 15/021,846, filed on Mar. 14, 2016.
(60) Provisional application No. 61/876,946, filed on Sep. 12, 2013.

(51) Int. Cl. B60N 2/50; B60N 2/30; B60N 2/14; B60N 2/06; B60N 2/015; B60N 2/68; B60N 2/01

(52) U.S. Cl. CPC B60N 2/503; B60N 2/68; B60N 2/509; B60N 2/3093; B60N 2/01; B60N 2/06; B60N 2/015; B60N 2/14

(57) ABSTRACT

A vehicle seat can comprise: a base; a back connected to the base; an arm extending from the base; wherein the arm is configured to attach to a roof rail of a vehicle. A vehicle can comprise: a steering column; engine; a roof comprising a rail; and passenger compartment, wherein the passenger compartment comprises the vehicle seat, wherein the arm is attached to the rail. A method of arranging seating in a vehicle can comprise: sliding an arm of the vehicle seat horizontally along a slot in a roof rail and/or crossrail.

### CROSS REFERENCE TO RELATED APPLICATIONS

This application is a continuation-in-part of U.S. patent application Ser. No. 15/021,846 filed Mar. 14, 2016 which claims benefit of International Application No. PCT/IB2014/064471 filed on Sep. 12, 2014 and U.S. Patent Application Ser. No. 61/876,946 filed Sep. 12, 2013 all of which are incorporated herein by reference in their entirety.

### TECHNICAL FIELD

The present application relates to a vehicle seating layout, and specifically relates to a seating layout that includes hanging seats.

BACKGROUND

Automotive interior design has remained the same for many years. The arrangement includes seats affixed at the bottom to the chassis facing forward (i.e., the direction in which the vehicle will travel). In other vehicles, such as subways, trains, and the like, some seats may face sideways or toward the back, but all are affixed to the chassis at their base.

What is needed in the art s a seating design that enables greater within the vehicle.

### SUMMARY

Disclosed herein are seats configured to attach to the roof of the vehicle, vehicles comprising the same, and methods of using the same.

In an embodiment, A method of arranging a seat within a vehicle, comprises: moving a vehicle seat along a roof rail in a vehicle and then connecting the vehicle seat to a floor of the vehicle. The vehicle seat comprises: a base; a back connected to the base; an arm extending from the back; wherein the arm is attached to the roof rail; and wherein other than the arm connection to the roof rail, the seat is free of connections that permanently anchor the seat to the vehicle chassis.

In an embodiment, a vehicle seat comprises: a base; a back connected to the base; an arm extending from the base; wherein the arm is configured to attach to a roof rail of a vehicle.

In an embodiment, a vehicle, comprises: a steering column; engine; a roof comprising a rail; and passenger compartment, wherein the passenger compartment comprises the vehicle seat, wherein the arm is attached to the rail. The vehicle seat comprises a base, a back connected to the base, and an arm extending from the base.

In an embodiment, a method of arranging seating in a vehicle comprises: sliding an arm of the vehicle seat horizontally along a slot in a roof rail and/or crossrail. The vehicle seat comprises a base, a back connected to the base, and an arm extending from the base.

These and other features are more particularly described below.

### BRIEF SUMMARY OF THE DRAWINGS

The following is a brief description of the drawings wherein like elements are numbered alike and which are presented for the purposes of illustrating the exemplary embodiments disclosed herein and not for the purposes of limiting the same.

FIG. 1. is a cross-sectional partial view of an embodiment of hanging seats attached to a roof.

FIG. 2 is an overhead view of an embodiment of a vehicle illustrating possible movements of the seats therein.

FIG. 3 is a partial perspective view of an embodiment of a vehicle illustrating the movement of seats.

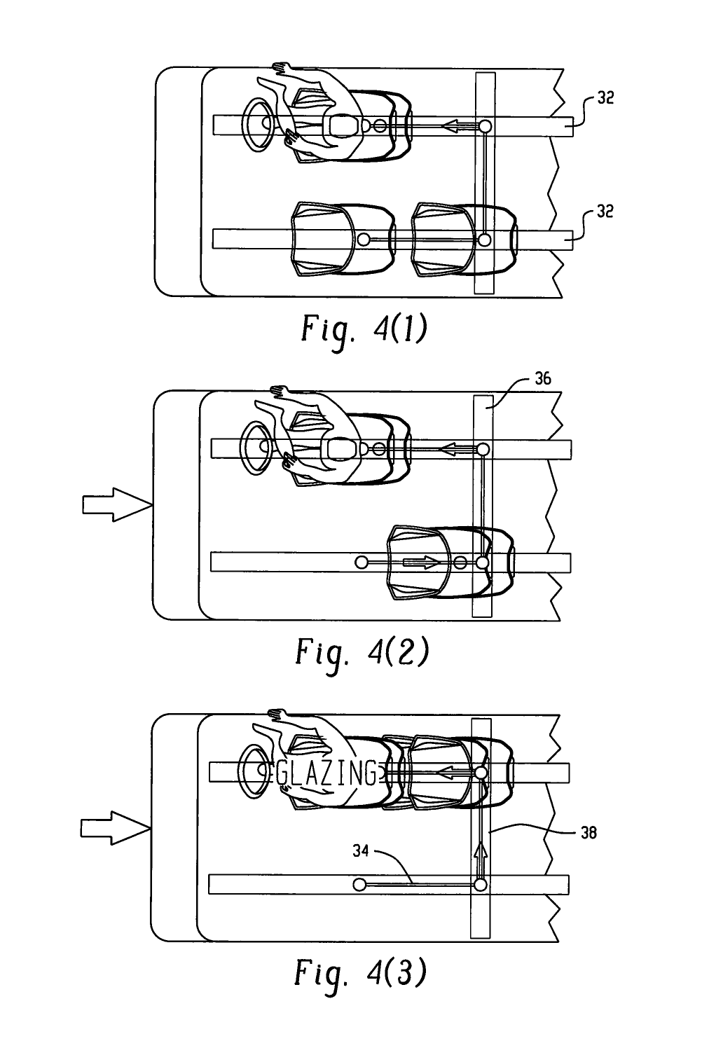

FIG. 4 is a series of overhead views illustrating various embodiments of the seats movements, including stacking of the seats to form free space (illustrations 1-4), forward and backward movement of the seat, e.g., to create space or to reduce collision impact (illustration 5), and rotation of the seats, e.g., to enable facile egress and ingress (illustration 6).

FIG. 5 is a partial perspective view illustrating an embodiment of stacked seats and free space.

FIG. 6 is a partial perspective view illustrating an embodiment of an egress scenario from a vehicle.

FIG. 7 is a partial perspective view illustrating an embodiment of a social flexibility scenario from a vehicle.

### DETAILED DESCRIPTION

Automotive interior space has been very much conventional from its beginning. Automotive interior design has remained the same for many years. Almost all of today's cars use conventional seating arrangement that is two rows of seats which are fixed to the chassis allowing its back to recline forward or backward. In cars, seats are essentially fixed to the chassis at their base and hence there is very limited scope for reconfiguration, e.g., to optimize the space according to the use scenario. For example, with a single passenger, the driver, in the car with a lot of luggage. The driver could be short of space and unable to manipulate the vehicle so as to optimize the available interior space even if he's traveling alone. Additionally, current seating layout in cars does not facilitate sociopetal arrangement.

In the present design, seats are hung from the roof frames of the vehicle. Optionally, these seats can be slid along the rails. This seating layout offers a wide range of flexibility to the user depending upon the use scenario. In this hanging seat concept, a user can change the interior layout according to the situation, thereby allowing greater flexibility within the same interior space. A further option comprises the seats being configured to slide backwards during a frontal impact collision along the rails. During crash of vehicle (frontal impact), sliding of seats backward can minimize the impact, prevent intrusion damage, and enhance the safety aspect. Optionally, the seat base and/or arm can further comprise safety features that can be actuated to provide stability during an impact.

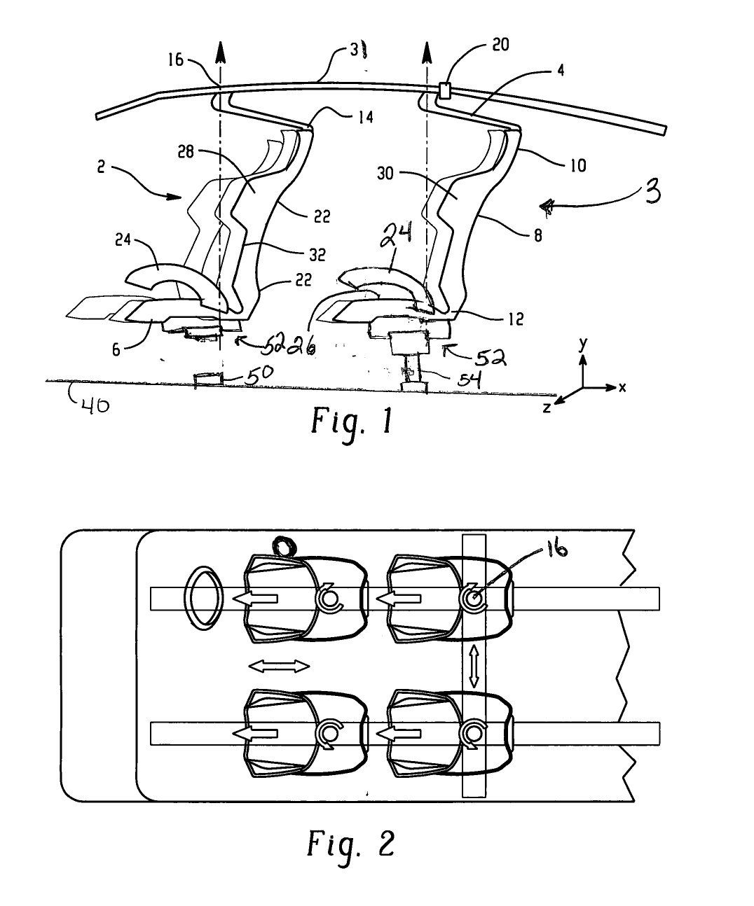

Referring to FIG. 1, the seat 2 has a base 6 connected to a back 8, with an arm 4 extending from the back 8 and configured to attach the seat 2 to a vehicle roof 31. The seat 2 can be rigid, e.g., with base 6 and back 8 a single unit, or can be flexible, wherein a base hinge 12 connects the base 6 and back 8, enabling the angle of the base to be changed with respect to the back (e.g., pivoted upward against the back 8). Optionally a clip, lock, or other mechanism can retain the base 6 in the folded position against the back 8. Similarly, a back hinge 14 can connect the back 8 and arm. 4 such that the back 8 can move with respect to the arm 4. Optionally, the back hinge 14 can allow a change in angle between the arm 4 and the back 8 to enable reclining or inclining, and/or to allow the seat to pivot around the arm 4.

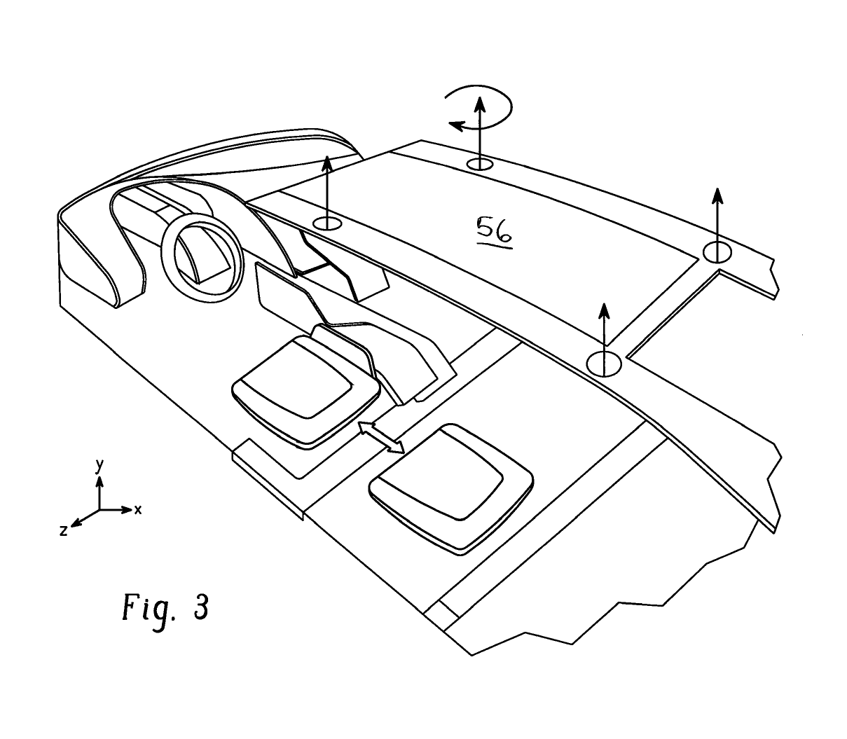

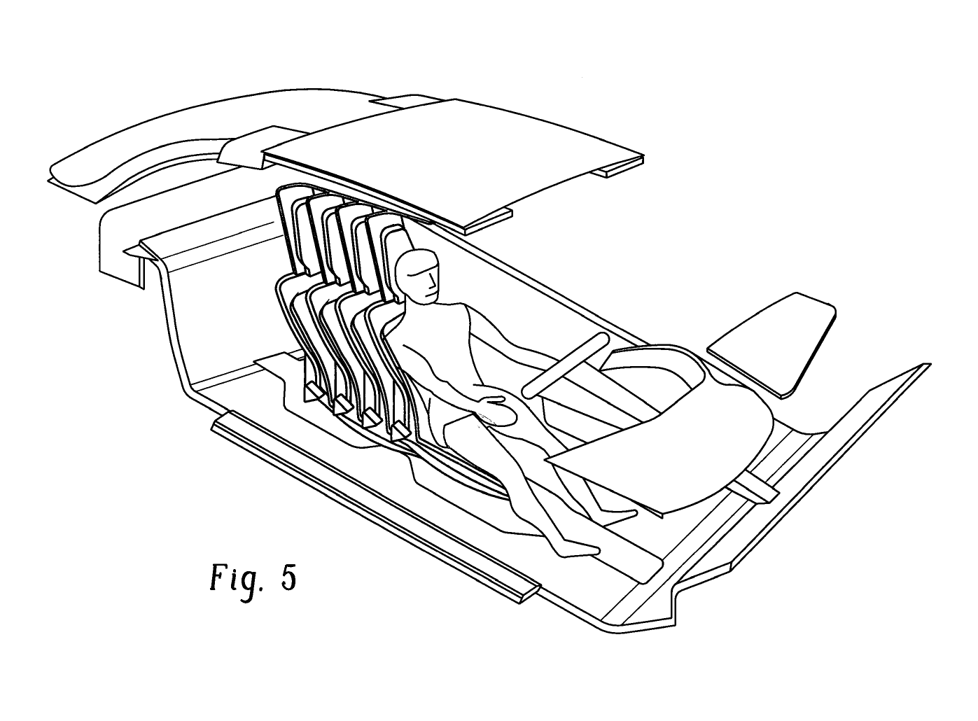

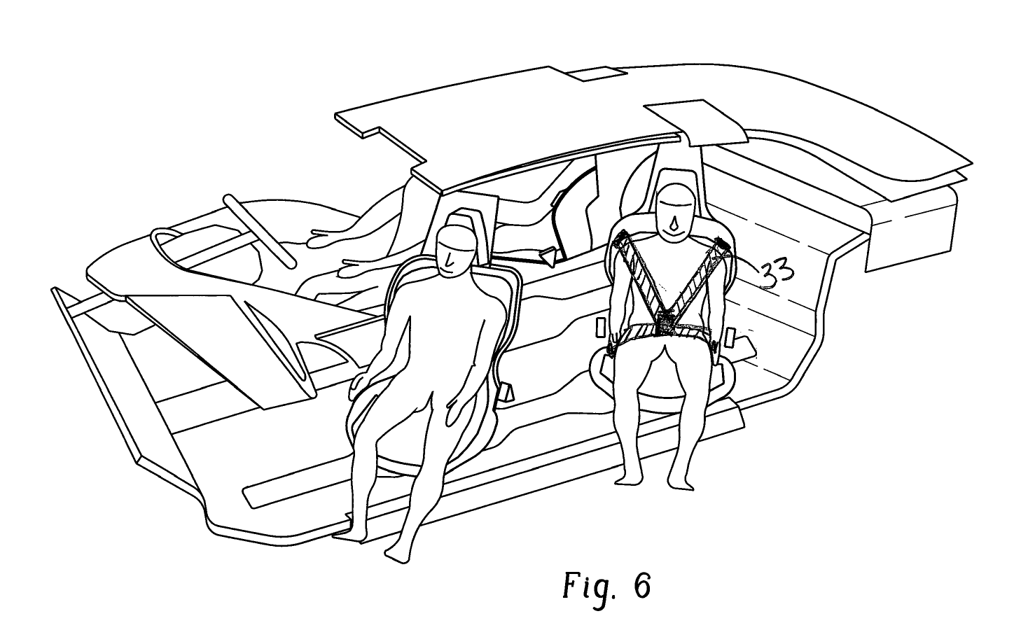

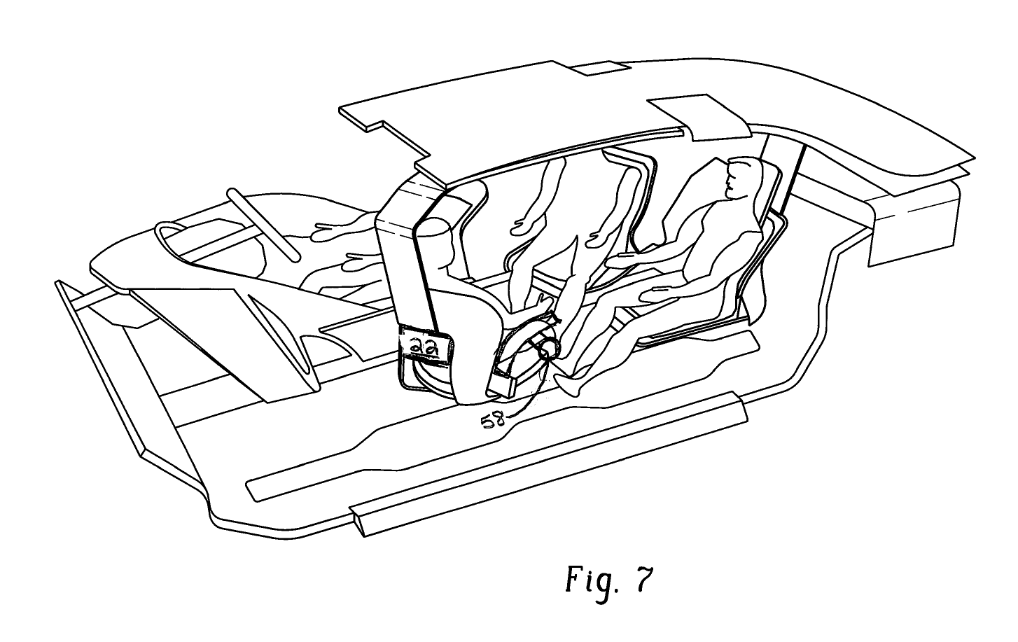

Pivoting of the seat 2 can be accomplished at the connection of the arm 4 to the roof rail 32, 36, e.g., using a seat revolving hinge 16 (see also FIG. 2). The roof rails can be located on sides of a transparent roof area 56 (e.g., at least one of a sun roof and a moon roof). The seat 2 can be configured to pivot around the x axis, and/or to slide along slot(s) 34 to enable sliding along the x axis. Enabling sliding of the seats 2 allows the seats 2 to be gathered together (e.g., stacked; see FIG. 5). Similarly, enabling pivoting along the vertical axis (e.g., the y axis) allows rotation, e.g., easy ingress and egress from the vehicle (see FIG. 6), and/or social flexibility (e.g., FIG. 7) or for the installation of a rear facing infant seat in a location more visible to the driver. In FIG. 6, the egress scenario from the vehicle is illustrated wherein users can turn the seats and simply get out from the vehicle with ease. This is very useful especially for the elderly and disabled people. In FIG. 7, an interactive layout is illustrated wherein as a seat can be swiveled around the connection between the arm and the roof, people inside the vehicle can arrange a configuration that facilitates an interactive space environment with ease.

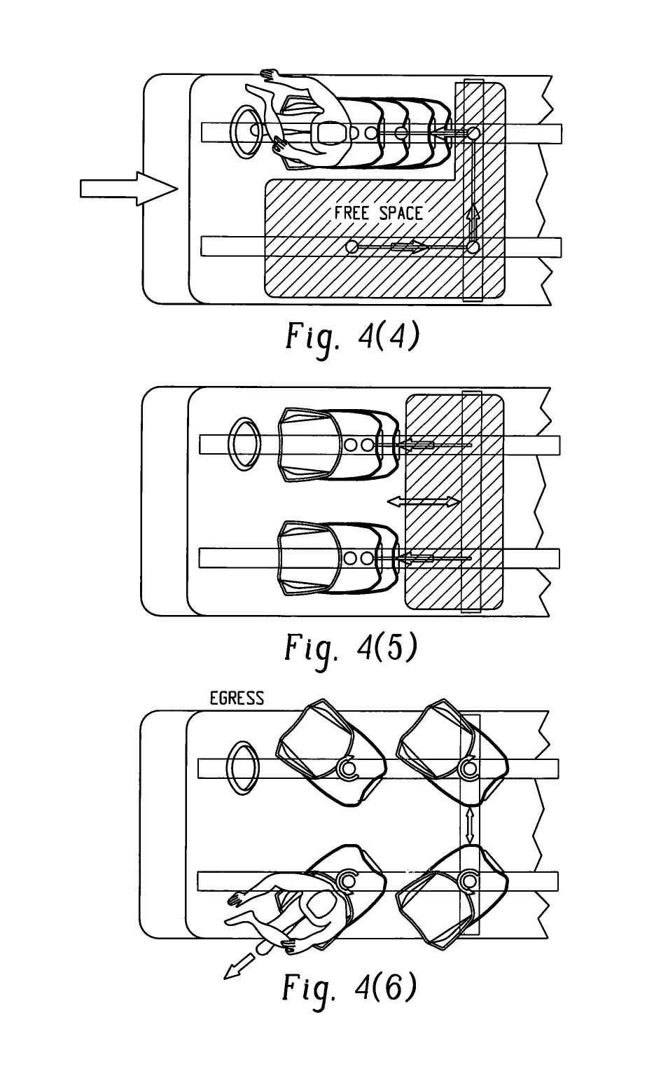

As illustrated in the views shown in FIG. 4 seats are hung from the frame(s) on the roof (e.g., two rails) which support a panoramic roof as well. There can be additional rail(s), cross rail(s) 36, extending between the main rails 32. The cross rail(s) 36, comprising cross slot(s) 38, enable the seats to slide sideways, between main rails 32. As used herein, main rails extend in an x direction, e.g., from the front to the back of the vehicle. As used herein, cross rails extend in a y direction, between the sides of the vehicle (e.g., driver's side and passenger's side).

This design can further enhance safety. For example, during a frontal crash impact, the seats can slide on the frame (rails) and move backward. This movement is in the direction of force, hence minimizing the impact. Optionally, the seat base 6 can have base safety feature 18 (see FIG. 1). For example the base safety feature 18 can comprise a braking mechanism that creates friction as the seat moves during an impact to reduce and/or control the speed of the movement, and/or to transfer energy from the seat to the chassis of the vehicle. Alternatively, or in addition, the base safety feature 18 can provide stability to the seat. The safety features could include an actuation member (e.g., 18) such as cylinder arm, telescopic arm, spring, or a combination comprising at least one of the foregoing. The actuation can be hydraulic, pneumatic, mechanical, or a combination comprising at least one of the foregoing. For example, the actuation member could actuate to engage an anchor fixedly attached to the chassis of the vehicle as is illustrated in FIG. 1. In FIG. 1, anchor 50 is fixedly attached to the chassis 40. Actuation member 52 has a telescopic arm 54. The actuation member is in a closed position on seat 2, and an engaged position on seat 3.

The arm safety feature 20, as with the base safety feature 18, can also optionally provide controlled deceleration of the seat during impact, and/or controls the speed of the seat movement, and/or be designed to transfer energy from the seat to the roof rails of the vehicle.

Other safety features of the seat can include seat belt(s) 33 and/or airbag(s) 22. The seat belt 33 can be a standard shoulder and lap belt, a harness (e.g., a five-point harness), and/or a convertible seat belt that can be converted from a shoulder and lap belt to a harness. The airbag(s) 22 can, for example, be located in the back 8 and/or base 6 of the seat 2. These airbag(s) can be designed and located to protect passengers seated behind the seat (e.g., in another seat), such as for head protection and/or leg protection, and/or can be designed and located so as to provide energy absorption during a collision for the occupant of the seat.

The seats 2 can further optionally include various comfort features, such as arm rests 24, a head rest 10 (which is optionally adjustable), base cushion 26, back cushion 28, supports 30. Possible supports 30 include head supports, shoulder supports, and so forth. Optionally, the supports 30 can be adjustable to enlarge or narrow the width of the seat back 8 to enable a larger occupant (e.g., an adult or a child's car seat) or smaller occupant (e.g., a child). Similarly, the back 8 and/or base 6 can be adjustable (e.g., telescoping), thereby enabling them to be adjusted depending upon the size of the occupant. This could even eliminate the need for child car seats, such as booster seats. Other possible comfort features include beverage holders 58 (e.g., cup holders attached to the seat, such as to the arm rest) (see FIG. 7),

Set forth below are some embodiments of the vehicle seat as well as vehicles comprising the seat and methods of using the seat.

Embodiment 1: A vehicle seat, comprising: a base; a back connected to the base; an arm extending from the base; wherein the arm is configured to attach to a roof rail of a vehicle.

Embodiment 2: The seat of Embodiment 1, wherein the base and the back are connected with a hinge.

Embodiment 3: The seat of any of Embodiments 1-2, wherein the arm and the back are connected with a hinge.

Embodiment 4: The seat of any of Embodiments 1-3, wherein the base is free of connections that can permanently anchor the seat to a vehicle chassis,

Embodiment 5: The seat of any of Embodiments 1-3, wherein the base is free of connections that connect the seat to a vehicle chassis such that the seat movement is restricted by rails below the base.

Embodiment 6: The seat of any of Embodiments 1-3, wherein other than safety features that engage during an impact, the base is free of connections that anchor the seat to a vehicle chassis.

Embodiment 7: The seat of any of Embodiments 1-6, further comprising a base safety feature comprising a braking mechanism that creates friction as the seat moves during an impact.

Embodiment 8: The seat of any of Embodiments 1-7, further comprising a base safety feature configured to transfer energy from the seat to the chassis of the vehicle during an impact.

Embodiment 9: The seat of any of Embodiments 1-8, further comprising an arm safety feature that provides controlled deceleration of the seat during impact,

Embodiment 10: The seat of any of Embodiments 1-9, further comprising an arm safety feature that controls the speed of the seat movement during an impact.

Embodiment 11: The seat of any of Embodiments 1-10, further comprising an arm safety feature that transfers energy from the seat to the roof rails of the vehicle during an impact.

Embodiment 12: The seat of any of Embodiments 1-11, further comprising at least one of a seat belt and an airbag.

Embodiment 13: The seat of Embodiment 12, further comprising the seat belt, wherein the seat belt comprises at least one of a shoulder and lap belt, a harness, and a convertible seat belt that is convertible from a shoulder and lap belt to a harness.

Embodiment 14: The seat of any of Embodiments 12-13, comprising the airbag, wherein the airbag is located in at least one of the back and the base of the seat.

Embodiment 15: The seat of any of Embodiments 1-14, further comprising at least one of an arm rest, a head rest, a base cushion, a back cushion, and supports.

Embodiment 16: The seat of Embodiment 15, comprising the support, wherein the support is adjustable to enlarge or narrow the width of the seat back.

Embodiment 17: The seat of any of Embodiments 1-16, wherein at least one of the back and the base 6 are adjustable enabling them to be adjusted depending upon the size of the occupant.

Embodiment 18: The seat of any of Embodiments 1-17, further comprising a base safety feature, wherein the safety features comprise a cylinder arm, a telescopic arm, a spring, or a combination comprising at least one of the foregoing.

Embodiment 19: The seat of any of Embodiments 6-11 and 18, wherein the safety feature is hydraulic, pneumatic, mechanical, or a combination comprising at least one of the foregoing.

Embodiment 20: The seat of any of Embodiment 19, wherein the safety feature is configure to actuate to engage an anchor fixedly attached to a chassis of a vehicle.

Embodiment 21: The seat of any of claims 1-17, wherein the arm has an adjustable length. For example, the arm can telescope, enabling the location of the base between the chassis and the roof to be adjusted.

Embodiment 22: A vehicle, comprising: a steering column; engine; a roof comprising a rail; and passenger compartment, wherein the passenger compartment comprises the seat of any of Embodiments 1-21, wherein the arm is attached to the rail.

Embodiment 23: The vehicle of Embodiment 22, wherein the seat can pivot around a vertical axis.

Embodiment 24: The vehicle of any of Embodiments 22-23, wherein the seat can slide horizontally.

Embodiment 25: The vehicle of any of Embodiments 22-24, comprising a plurality of seats, and wherein the seats can be stacked.

Embodiment 26: The vehicle of any of Embodiments 22-25, wherein the arm is removably attached to the rail such that the seat can be removed from the vehicle.

Embodiment 27: The vehicle of any of Embodiments 22-26, wherein the rail comprises a slot.

Embodiment 28: The vehicle of any of claims 22-27, wherein the seat can slide across the vehicle, from one side to another side. In other words, wherein the vehicle comprise a passenger side and a driver side, and wherein the seat can slide according to at least one of from the driver side to the passenger side, from the passenger side to the driver side, and back and forth between the passenger side and the driver side.

Embodiment 29: The vehicle of any of claims 22-27, wherein the seat can rotate greater than or equal to 180°.

Embodiment 30: The vehicle of any of claims 22-27, wherein the vehicle has a front passenger space adjacent to a windshield, and a rear passenger space located between the front passenger space and a rear of the vehicle, and wherein the seat can slide in an x direction, from the front passenger space to the rear passenger space.

Embodiment 31: The vehicle of any of claims 22-30, wherein the vehicle has a driver side and a passenger side, and wherein the seat can slide in a y direction, from the driver side to the passenger side.

Embodiment 32: The vehicle of any of Embodiments 22-24, comprising a plurality of seats, and wherein the seats can slide in an x direction and a y direction such that the seats can be stacked behind a driver seat.

Embodiment 33: A method of arranging seating in a vehicle, comprising: sliding an arm of the seat of any of Embodiments 1-21 horizontally along a slot in a roof rail.

All ranges disclosed herein are inclusive of the endpoints, and the endpoints are independently combinable with each other ranges of “up to 25 wt. %, or, more specifically, 5 wt. % to 20 wt. %”, is inclusive of the endpoints and all intermediate values of the ranges of “5 wt. % to 25 wt. %” etc.). “Combination” is inclusive of blends, mixtures, alloys, reaction products, and the like. Furthermore, the terms “first,” “second,” and the like, herein do not denote any order, quantity, or importance, but rather are used to denote one element from another. The terms “a” and “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the film(s) includes one or more films). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications, variations, improvements, and substantial equivalents.

What is claimed is:

1. A method of arranging a seat within a vehicle, comprising:
moving a vehicle seat along a roof rail in a vehicle and then connecting the vehicle seat to a floor of the vehicle, wherein the vehicle seat comprises
a base;
a back connected to the base;
an arm extending from the back;
wherein the arm is attached to the roof rail; and
wherein other than the arm connection to the roof rail, the seat is free of connections that permanently anchor the seat to the vehicle chassis.

2. The method of claim 1, wherein the vehicle comprises a driver's seat and at least 3 passenger seats, further comprising moving the passenger seats along the roof rail until the passenger seats are all behind a driver's seat.

3. A vehicle, comprising:
a steering column;
an engine;
a roof comprising the roof rail; and
a passenger compartment, wherein the passenger compartment comprises a seat, wherein the seat comprises
a base including a base safety feature comprising an actuation mechanism that connects the seat and a vehicle chassis with an actuation member, wherein the actuation mechanism has an actuation that is at least one of hydraulic, pneumatic, and mechanical, and wherein the actuation member comprises a cylinder arm, a telescopic arm, a spring, or a combination comprising at least one of the foregoing;
a back connected to the base;
an arm extending from the back; and
wherein the arm is attached to the roof rail.

4. The vehicle of claim 3, wherein the seat can pivot around a vertical axis, wherein the seat can be swiveled around a connection between the arm and the roof rail.

5. The vehicle of claim 3, wherein the roof rails include main rails that extend from the front to the back of the vehicle, and cross rails that extend between the main rails, wherein the cross rails enable the seats to slide sideways between the sides of the vehicle.

6. The vehicle of claim 3, comprising a plurality of seats, and wherein seats are stackable behind a driver's seat.

7. The vehicle of claim 3, wherein the arm is removably attached to the rail such that the seat can be removed from the vehicle.

8. The vehicle of claim 3, wherein other than the arm connection to the roof rail, the seat is free of connections that permanently anchor the seat to the vehicle chassis.

9. The vehicle of claim 3, wherein the actuation member comprises a telescopic arm.

10. A vehicle seat, comprising:
a base;
a back connected to the base;
an arm extending from the back;
wherein the arm is configured to attach to a roof rail of a vehicle; and
wherein other than the arm connection to the roof rail, the seat is free of connections to permanently anchor the seat to a vehicle chassis.

11. The vehicle seat of claim 10, further comprising at least one of
a seat belt, wherein the seat belt comprises at least one of a shoulder and lap belt a harness, and a convertible seat belt that is convertible from a shoulder and lap belt to a harness; and
an airbag, wherein the airbag is located in at least one of the back and the base of the seat, wherein the airbag is located to protect passengers seated behind the seat.

12. The vehicle seat of claim 10, wherein at least one of the back and the base are adjustable enabling them to be adjusted depending upon the size of the occupant.

13. The vehicle seat of claim 10, wherein the base comprises an actuation mechanism that connects the seat and a vehicle chassis with an actuation member, wherein the actuation mechanism has an actuation that is at least one of hydraulic, pneumatic, and mechanical, and wherein the actuation member comprises a cylinder arm, a telescopic arm, a spring, or a combination comprising at least one of the foregoing.

14. The vehicle seat of claim 13, wherein the actuation member comprises a telescopic arm.

15. The vehicle seat of claim 10, wherein the width of the seat back is adjustable.
